(19) United States
(12) Patent Application Publication
(10) Pub. No.: US 2026/0079498 A1
(43) Pub. Date: Mar. 19, 2026

(54) UNDERWATER SENSING SYSTEMS AND METHODS

(71) Applicant: The United States of America, as represented by the Secretary of the Navy, Arlington, VA (US)

(72) Inventors: Jeffrey Scott Ellen, San Diego, CA (US); Benjamin Michael Whitmore, San Diego, CA (US)

(73) Assignee: The United States of America, as represented by the Secretary of the Navy, Arlington, VA (US)

(21) Appl. No.: 18/890,268

(22) Filed: Sep. 19, 2024

(51) Int. Cl. G05D 1/606; B63G 8/00; G01C 21/20; G05D 1/228

(52) U.S. Cl. CPC G05D 1/606; B63G 8/001; G01C 21/20; G05D 1/2287; B63G 2008/004

(57) ABSTRACT

The present invention includes systems and methods for improving the process of detecting and classifying objects of interest using UUVs to survey the ocean. According to a particular embodiment, the present invention provides a more cost-efficient process by employing preconfigured heuristic operational scenarios, or supervised machine learning to fine-tune this process by integrating the use of environmental variables relating to the water in which data is gathered, and more particularly for classifying sonar images of the seafloor.

### FEDERALLY-SPONSORED RESEARCH AND DEVELOPMENT

The United States Government has ownership rights in this invention. Licensing and technical inquiries may be directed to the Office of Research and Technical Applications, Naval Information Warfare Center Pacific, Code 72120, San Diego, CA, 92152; voice: (619) 553-5118; email: NIWC_Pacific_T2@navy.mil. Reference Navy Case Number 210949.

### BACKGROUND OF THE INVENTION

Field of the Invention: The present invention relates generally to uncrewed underwater vehicles (UUVs). More particularly, the present invention relates to UUVs and underwater sensing systems and methods of gathering data.

Description of Related Art: UUVs are commonly used to survey the ocean, or other waterways, to detect and classify objects of interest. Such an UUV may be deployed to explore an underwater region using sensors configured to gather data to locate, identify, count or measure underwater objects of interest. Common sensors may include sonar, video imagery and LIDAR (Light Detection and Ranging).

One problem with conventional UUV operations for underwater sensing is that the UUV is executing planned transects, maneuvers, and sensing regardless of environmental conditions. When UUVs operate independent of environmental conditions, and conditions are unfavorable, poor data quality is more likely. Often the only remedy is costly secondary deployments occurring hours to days later, if at all. One conventional solution to this problem includes attempting to redeploy the sensor when conditions have improved. Another conventional solution to this problem is deploying a system with a “live feed” to a human operator so they can adjust focus or take other corrective actions. However, this requires an umbilical/tether from the sensor to the surface, and is therefore expensive, and infeasible for deeper or more remote locations.

Another problem with conventional algorithms and methods of detecting, recognizing and classifying objects in such underwater sensory data is operation in a single modality, i.e., assigning probabilities, detections, or “hits”, and classifications independent of the characteristics of the water in which the data is being sensed. Degraded environmental conditions in the water, e.g., turbidity, salinity, temperature and internal waves, as well as vehicle instability may degrade video (see, S. K. Upadhyay and M. Papadakis, “Improving the visibility of underwater video in turbid aqueous environments,” in SNAME Maritime Convention, OnePetro, September 2020) and sonar imagery (see, e.g., R. E. Hansen, H. J. Callow, T. O. Sæbø, and S. A. V. Synnes, “Challenges in seafloor imaging and mapping with synthetic aperture sonar,” IEEE Trans. Geosci. Remote Sens. 49(10), 2011, pp. 3677-3687; (hereinafter “Hansen et al.”) and R. E. Hansen, A. P. Lyons, T. O. Sæbø, H. J. Callow, and D. A. Cook, “The effect of internal wave-related features on synthetic aperture sonar,” IEEE J. Ocean. Eng. 40(3), 2014, pp. 621-631).

The impact of degraded environmental conditions can be difficult to generalize because of the inherent horizontal and vertical patchiness of coastal ocean regions. The generalization of these relationships may further be complicated because many of these in situ variables have complex relationships that vary by the time of year or even time of day. Such variables may be driven by both physical phenomena, e.g., diurnal heating, cooling and wind mixing, as well as diel vertical migration of planktonic organisms (see, e.g., J. F. Price, R. A. Weller, and R. Pinkel, “Diurnal cycling: Observations and models of the upper ocean response to diurnal heating, cooling, and wind mixing,” J. Geophys. Res. Oceans. 91(C7), 1986, pp. 8411-8427; and D. H. Cushing, “The vertical migration of planktonic,” Crustacea. Biol. Rev. 26, 1951, pp. 158-192).

In view of the foregoing and for other reasons that will become evident, there exists a need in the art for improved underwater sensing systems.

### SUMMARY OF THE INVENTION

An embodiment of an uncrewed underwater vehicle (UUV) sensing system controller in communication with an UUV controller, the UUV controller adapted for guiding an UUV according to a preselected navigational behavior during operation of the UUV during a mission, is disclosed. The UUV sensing system controller may further be adapted to: receive tactical data from tactical sensors located on the UUV and having preselected tactical sensor settings used to find and classify objects of interest under water; receive environmental data including water parameter measurements from environmental sensors located on an UUV; and output selected modifications to the preselected tactical sensor settings and/or the preselected navigational behavior in response to the environmental data received during the mission, thereby improving in situ tactical data collection performed by the tactical sensors relative to data collection performance without the selected modifications based on the environmental data.

An embodiment of an UUV including an UUV controller, in communication with a navigation subsystem, a propulsion subsystem, a communication subsystem, a power subsystem, tactical sensors, environmental sensors, and a sensing system controller in communication with the UUV controller, wherein the UUV is configured for deployment on a preselected navigational behavior in water to detect and classify objects of interest in the water using the tactical sensors, is disclosed. According to this embodiment of an UUV, the sensing system controller further includes: a memory for storing data and a computer program, the computer program including computer instructions for modifying both the preselected navigational behavior and tactical sensor operating characteristics in response to environmental data gathered by the environmental sensors; and a processor in communication with the environmental sensors, the tactical sensors, and the memory, the processor configured for executing the computer program.

An embodiment of a method for improving data gathering performed by an UUV is disclosed. The embodiment of the method includes providing the UUV configured with a preselected navigational behavior for operation in water to detect and classify objects of interest in the water, the UUV further configured with environmental sensors having preselected environmental sensor settings for gathering environmental data relating to the water, the UUV further configured with tactical sensors for gathering tactical data relating to the objects of interest; deploying the UUV according to the preselected navigational behavior; gathering the environmental data with the environmental sensors; gathering the tactical data with the tactical sensors; selecting one or more preconfigured heuristic operational scenarios directing modifications to the preselected environmental sensor settings and the preselected navigational behavior based on the gathered environmental data, or alternatively, incorporating the gathered environmental data into a supervised machine learning algorithm model; modifying the preselected environmental sensor settings based on the gathered environmental data; and modifying the preselected navigational behavior based on the gathered environmental data.

An embodiment of a method for improving data collected by an UUV configured with environmental sensors for gathering environmental data relating to water, the UUV further configured with tactical sensors for gathering tactical data relating to objects of interest in the water, is disclosed. The embodiment of the method may include gathering the environmental data with the environmental sensors during a mission; concurrently gathering the tactical data with the tactical sensors during the mission; incorporating the gathered environmental data into a supervised machine learning algorithm performing detection and classification of the objects of interest discovered in the gathered tactical data during the mission.

### BRIEF DESCRIPTION OF THE DRAWINGS

The following drawings illustrate exemplary embodiments for carrying out the invention. Like reference numerals refer to like parts in different views or embodiments of the present invention in the drawings.

FIG. 1 is a block diagram of an UUV, according to the present invention.

FIG. 2 is a diagram illustrating exemplary adaptive sensing and adaptive navigation for improved real time UUV tactical data gathering operations, according to the present invention.

FIG. 3 is a diagram illustrating exemplary application of the invention to 1-dimensional data, according to the present invention.

FIG. 4 is a diagram illustrating exemplary application of the invention to 2-dimensional data, according to the present invention.

FIGS. 5A-5D illustrate exemplary machine learning architectures, including three architectures for including metadata, according to the present invention.

FIG. 6 is a flowchart of a method for improving data gathering performed by an UUV, according to the present invention.

FIG. 7 is a flowchart of an embodiment of a method for improving data collected by an UUV configured with environmental sensors for gathering environmental data relating to water, and further configured with tactical sensors for gathering tactical data relating to objects of interest in the water, according to the present invention.

### DETAILED DESCRIPTION

The disclosed methods and systems below may be described generally, as well as in terms of specific examples and/or specific embodiments. For instances where references are made to detailed examples and/or embodiments, it should be appreciated that any of the underlying principles described are not to be limited to a single embodiment but may be expanded for use with any of the other methods, apparatuses and systems described herein as will be understood by one of ordinary skill in the art unless specifically otherwise stated.

The present invention includes systems and methods for improving the process of detecting and classifying objects of interest using UUVs to survey the ocean. More particularly, the present invention provides improved tactical data gathering performance by employing preconfigured heuristic operational scenarios, or alternatively, supervised machine learning to fine-tune existing tactical data gathering processes by integrating the use of environmental variables in particular for classifying sonar images of the seafloor. It will be understood that there are numerous possible applications for the technological innovation provided. However, for exemplary illustration, at least two use cases of particular interest to the present Applicant are described herein with added detailed description.

The purpose of the present invention is to enable better results from recognition and classification methods utilized in underwater sensing systems for finding, counting, or measuring objects of interest. The invention achieves this by improving the time and cost efficiency of underwater sensing efforts, such as those embedded in an UUV by enabling adaptive sensing. It will be understood that the environmental sensors may be statically placed (i.e., mounted to a pier piling) or dynamically placed (i.e., measuring from a moving UUV). Embodiments of the present invention may also simultaneously leverage multiple environmental sensors to improve the data quality and detection performance of tactical data sensors.

The inventors have confirmed a correlation between certain environmental observations and UUV sensor data quality degradation, see, Benjamin M. Whitmore, Jeffrey S. Ellen and Michael C. Grier, “Toward improving unmanned underwater vehicle sensing operations through characterization of the impacts and limitations of in situ environmental conditions”, OCEANS 2022, Hampton Roads 2022 Oct. 17 (pp. 1-4). IEEE. DOI: 10.1109/OCEANS47191.2022.9977345, (hereinafter, “Whitmore et al.”), hereby incorporated by reference for all purposes as if fully set forth herein. For sonar particularly, it is known that the refraction that occurs with changes in sound speed is present in the sensed data, see Hansen et al. Furthermore, the inventors have discovered that on-vehicle temperature and salinity measurements may be sufficient to correlate to operator-identified refraction in the sensed data.

The US Navy employs UUVs for various applications. For example, and not by way of limitation, minehunting involves looking for static objects on the seafloor and may also include floating mines. In the context of underwater minehunting, an UUV typically carries two types of sensors. The tactical sensors (e.g., side-scan sonar, optical video, LIDAR), and the environmental sensors (e.g., salinity, temperature, depth, turbidity, and chlorophyll-a) which are gathered alongside vehicle behavior metrics (e.g., vehicle 3D motion, altitude, heading, speed, roll/pitch/yaw rates). A minehunter generally uses an imaging sonar to detect and classify targets.

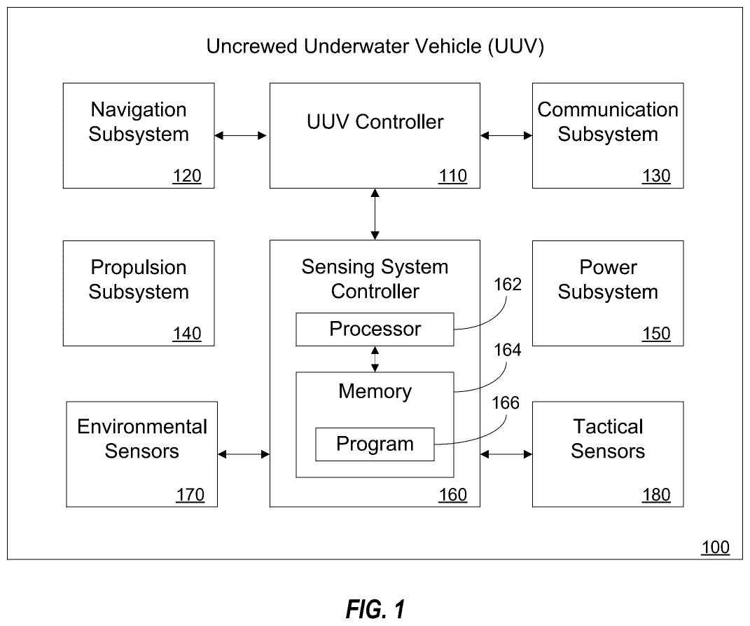

FIG. 1 is a block diagram of an UUV 100, according to the present invention. As shown in FIG. 1, UUV 100 may include an UUV controller 110. UUV 100 may further include a navigation subsystem 120 in communication with the UUV controller 110. The navigation subsystem 120 may be used to determine location and headings of the UUV 110. UUV 100 may further include a communication subsystem 130 in communication with the UUV controller 110. The UUV communication subsystem 130 may be used by surface vessel users to communication with the UUV 100 to determine its status and location. UUV 100 may further include a propulsion system 140 configured for moving the UUV 100 within water and at preselected and adjustable depths along its preselected navigation behaviors (transects, etc.) during operational missions. UUV 100 may further include a power subsystem 150 which may include one or more batteries (not shown) and a power controller (also not shown for simplicity of illustration) or other means of power storage (e.g., fuel cell, also not shown) and conversion to electrical energy suitable for powering electronics and other electrical equipment onboard the UUV 100.

As further illustrated in FIG. 1, UUV 100 may further include a sensing system controller 160 in communication with the UUV controller 110. The sensing system controller may further include a processor 162 and memory 164 for storing data and one or more computer programs 166 configured for implementing various aspects of the present invention as described herein. UUV 100 may further include environmental sensors 170 in communication with the sensing system controller 160. The environmental sensors 170 may be used for measuring environmental characteristics of the water in which the UUV 100 passes through. Various examples of environmental sensors 170 are described elsewhere herein. UUV 100 may further include tactical sensors 180 in communication with the sensing system controller 160. The tactical sensors 180 are used to perform the data gathering in accordance with mission objectives during UUV 100 operations underwater. Various examples of tactical sensors 180 are also described elsewhere herein.

### 1. Improving In Situ (Real Time) UUV Tactical Data Gathering Operations

One particularly useful application of the present invention is optimizing in situ, real time operations of an UUV, e.g., navigation, efficiency of collecting tactical data and collecting better tactical data. This particular application might manifest in one, or a combination, of the following nonexclusive examples: Example (a): The environmental sensors on board the UUV indication that visibility is poor. To compensate, the preselected (normal) altitude for UUV operation may be modified to collect imaging data at a lower altitude than normal to improve visibility. Alternatively, or in addition, the UUV may improve visibility directly by modifying spectral lighting, analogous to how a car might use fog lights, not necessarily brighter. In Example (a), preselected navigational behavior and/or preselected sensor settings may be adjusted to improve tactical data gathering in real time. Example (b): The environmental sensors indicate that refraction is likely. To compensate, the preselected (normal) lane spacing of UUV transects may be modified to collect data at a closer-than-normal lane spacing. In Example (b), a modification to the preselected navigational behavior resulted from the gathered environmental data. Example (c): The environmental sensors indicate that due to sand ripples, the UUV would collect better data by collecting data orthogonal to its current transects. Thus, the preselected (normal) UUV transect direction of travel for gathering image data may be modified to optimize data gathering along a different direction. In Example (c), a modification to the preselected navigation behavior is driven by gathered environmental data. The above examples are referred to herein as “heuristic operational scenarios” for which preselected environmental sensor settings may be adjusted on the fly, and/or preselected navigational behaviors may be modified on the fly based on the environmental data gathered, in order to improve quality or usefulness of the tactical data gathered.

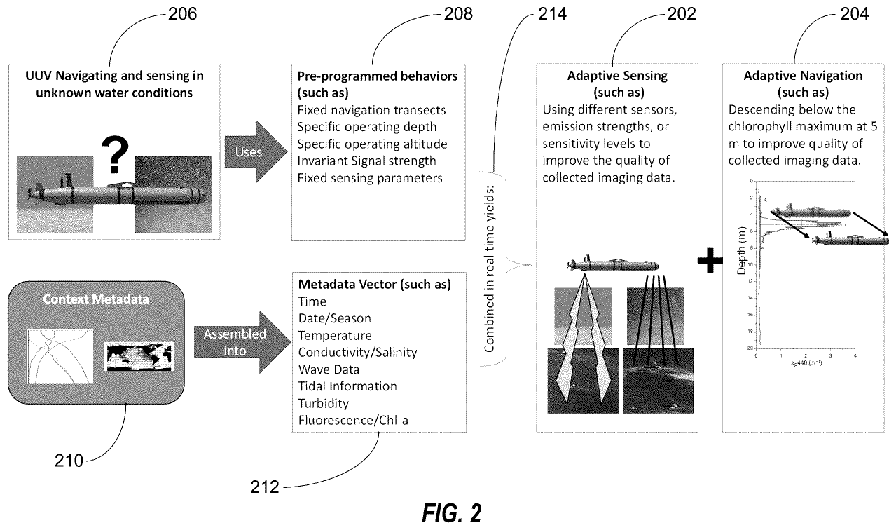

FIG. 2 is a diagram illustrating exemplary adaptive sensing 202 and adaptive navigation 204 for improved real time UUV tactical data gathering operations, according to the present invention. Embodiments of the present invention implementing the adaptive sensing 202 and adaptive navigation 204 described herein may be completely autonomous. Alternatively, the adaptive sensing 202 and adaptive navigation 204 described herein may be include preconfigured sets of behaviors. For example, and not by way of limitation, given poor visibility, instead of the UUV taking wildly exploratory actions to autonomously optimize data, it might change from one predefined navigational action plan to another. These predefined navigational action plans are also referred to herein as “heuristic operational scenarios”.

As shown in FIG. 2, the UUV may be deployed for navigating and sensing in unknown water conditions 206. Generally, the UUV will have preprogrammed operational behaviors 208 for operating under nominal conditions. Such preselected operational behaviors may include fixed navigation transects, specific operating depth, specific operating altitude above the seafloor, invariant sensing signal strength and fixed sensing parameters. Environmental data may be gathered from environmental sensors on-board the UUV or from other sources. Contextual metadata 210 may be derived from the environmental data. A nonexhaustive list of metadata 210 which may be assembled into metadata vectors 212 useful in this context may include time, date, season, water temperature, water conductivity, water salinity, wave data, tidal information, turbidity, water fluorescence, chlorophyll-a, etc. It will be understood that many of these exemplary types of environmental data are derived from onboard environmental sensors. However, according to other embodiments some of these environmental data, or derived context metadata 210 may also include offboard measurements and information, such as wave height, time of day, season, tidal schedule, etc. It will be understood that such externally observable parameters may be useful metadata for use in various embodiments of the present invention

As shown in FIG. 2, the preprogrammed UUV operational behaviors may be combined 214 in real time with the contextual metadata 210. This may be as rule-based heuristics, or in the form of vectors using a supervised machine learning model, yielding adaptive sensing 202 and adaptive navigation 204. Adaptive sensing 202 may include using different sensors, sensor emission strengths, or sensitivity levels to improve the quality of collected imaging data, according to various embodiments of the present invention. Adaptive navigation 204 may include descending below a sensed region of water that impairs imaging, e.g., descending below a chlorophyl maximum sensed at 5 m depth to improve quality of collected image data. Note the chlorophyll-a profile image shown in the adaptive navigation 204 block of FIG. 2 is reproduced from Dekshenieks, Margaret M., et al. “Temporal and spatial occurrence of thin phytoplankton layers in relation to physical processes”, Marine Ecology Progress Series 223 (2001): 61-71. It will be understood that sensing a chlorophyl maximum at a nominal or preselected depth and adjusting operating depth from nominal or preselected depth is exemplary only and that there are many other adjustments to preselected navigational behaviors that may be taken based on the context metadata 210.

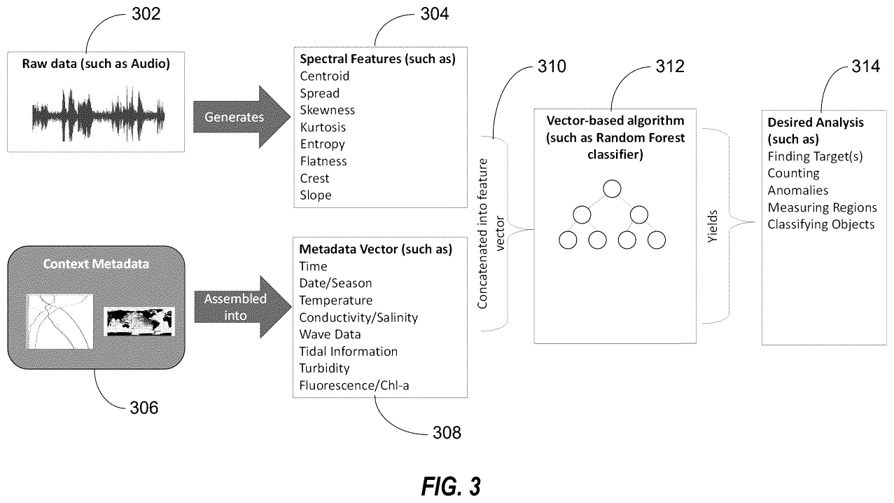

FIG. 3 is a diagram illustrating exemplary application of the invention to 1-dimensional (1D) data, according to the present invention. As shown in FIG. 3, 1D raw data, e.g., raw audio data 302, may be used to generate spectral features 304 of the raw 1D data 302. Exemplary spectral features 304 of 1D data might include: centroid, spread, skewness, kurtosis, entropy, flatness, crest, slope, etc. Context metadata 306 from environmental sensors (onboard and/or offboard) may be assembled into metadata vectors 308. Exemplary metadata vectors 308 may be derived from: time, date, season, temperature, conductivity, salinity, wave data, tidal information, turbidity, water fluorescence, chlorophyll-a, etc. As shown in FIG. 3, the spectral features 304 and metadata vectors 308 may be concatenated 310 into a feature vector for use in a vector-based machine learning algorithm 312, e.g., a Random Forest Classifier. The output of such a vector-based machine learning algorithm 312 may then yield a desired analysis 314 of the raw data 302. Exemplary desired analysis 314 may include finding targets, counting anomalies, measuring regions, classifying objects, etc.

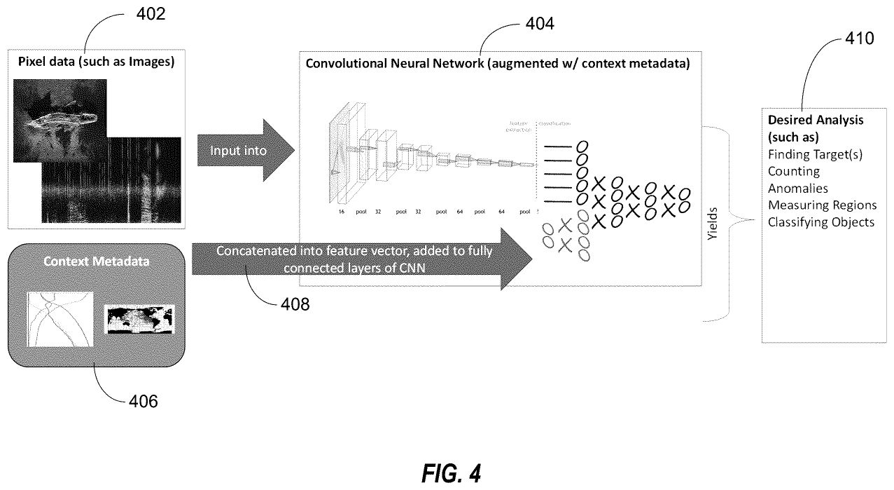

FIG. 4 is a diagram illustrating exemplary application of the invention to 2-dimensional (2D) data, according to the present invention. The 2D data may be any type of 2D data gathered by tactical sensors on an UUV. As shown in FIG. 4, pixel data 402, e.g., optical image or echogram, may be input into a convolutional neural network 404. Note that the graphical image shown in 404 is borrowed from J. S. Ellen, C. A. Graff, and M. D. Ohman, “Improving plankton image classification using context metadata”, cited herein. Context metadata 406 from environmental sensors (onboard and/or offboard) may be concatenated 408 into feature vectors and added to fully connected layers of the convolutional neural network 404 yielding an output of desired analysis 410. Again, the exemplary metadata 406 may be derived from: time, date, season, temperature, conductivity, salinity, wave data, tidal information, turbidity, water fluorescence, chlorophyll-a, etc. Exemplary desired analysis 410 may again include finding target(s), counting anomalies, measuring regions, classifying objects, etc.

### 2. Improving Analysis of UUV Collected Data

Another particularly useful application of the present invention is improving the analysis of data collected by the UUV. The classification of tactical sensor data for identified targets on the seafloor in the water may be performed using machine learning models. Such classification of the targets may be performed post-operations. However, given sufficient computing power and memory, the classification may also be performed real time. This second application of the present invention might also manifest in one, or a combination, of the following nonexclusive scenarios: Example (d): Based on overall environmental sensor data, the sensing system controller might select the best available machine learning model for that particular set of environmental metadata. For example, there could be a number of pre-trained machine learning models to select from, i.e., “the clear-water model”, “the cloudy-water model”, “the phytoplankton bloom model”, etc., from which a sensing controller might switch for tactical data gathering. Example (e): Utilizing both instantaneous environmental and vehicle behavior sensor data simultaneously with the presently collected tactical sensor data to improve the machine learning classification of future tactical sensor data as it is collected.

Exemplary embodiments aligned with example (d) may include training different machine learning algorithms based on aggregate environmental conditions. In addition to water quality models noted above, there could be models directed to other physical features of the seafloor, e.g., “the sand model”, “the pebbles model”, “the coral model”, according to various embodiments of the present invention. It will be understood that there may also be combination variant machine learning models that might also be selected, e.g., “the clear-pebbles model”, “the cloudy-coral model”, etc. Note that seafloor classification has been formalized by the National Geospatial-Intelligence Agency (NGA). Accordingly, such NGA seafloor classifications may be used as a framework for defining various machine learning models that may be employed consistent with the teachings of the present invention. Note further that each individual machine learning model may be a trained deep-learning model, according to various embodiments of the present invention.

Exemplary embodiments aligned with example (e) may also employ deep machine learning models. The inventors have described some specific implementations and results based on the deep machine learning approach in Jeffrey S. Ellen, Julia Craciun and Benjamin M. Whitmore. “Improving UUV Seafloor Machine Learning with Environmental Metadata”, OCEANS 2023-MTS/IEEE US Gulf Coast, 2023 Sep. 25 (pp. 1-4), IEEE, DOI: 10.23919/OCEANS52994.2023.10337248, (hereinafter, “Ellen et al.”) the contents of which are hereby incorporated by reference for all purposes as if fully set forth herein. The inventors have discovered that environmental measurements, e.g., water parameters and vehicle position, when taken concurrently with image acquisition, will improve classifier accuracy. For completeness, the relevant aspects of Ellen et al. are reproduced herein.

### EXPERIMENTAL DESIGN

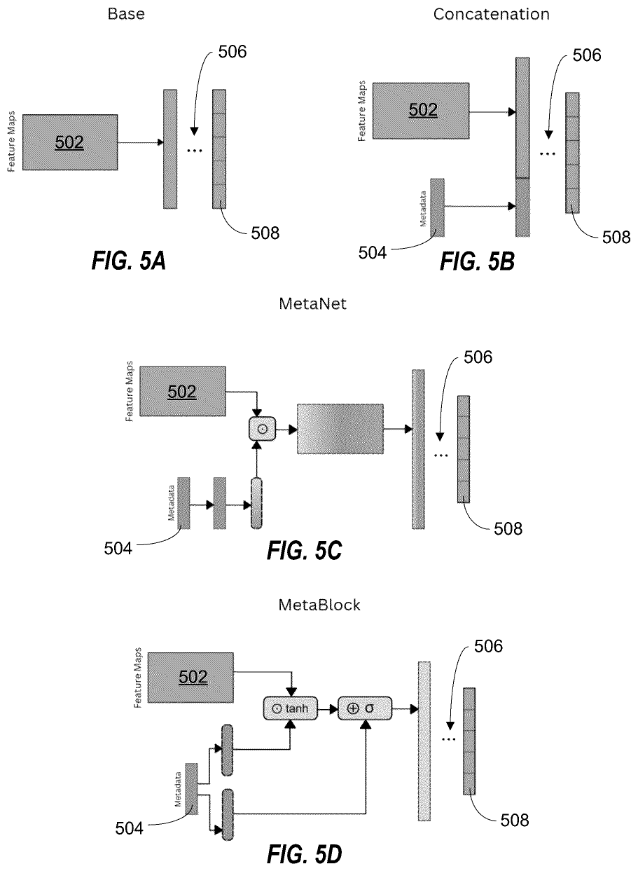

In order to demonstrate the improvement in classifier accuracy, the inventors considered a binary classification problem where exemplary seafloor images are given a single label from two possible classes: “man-made object” or “natural object”. The exemplary seafloor images were square image tiles created from larger, continual sensor transects. In practice, a contemporary machine learning algorithm will achieve detection/localization and classification in one step. However, both steps are not necessary to evaluate the efficacy of including environmental metadata on classification. The inventors then integrated environmental metadata with a select deep learning algorithm in three different ways, along with a baseline case, or “base”, that did not include metadata, see FIGS. 5A-5D and related description below. It will be understood that implementation including metadata requires more computations and memory vs. baseline.

### Dataset

The inventor's dataset consisted of 3760 images, primarily 42×42 single channel pixels. Of these, 2901 were labeled as “natural object” and 859 were labeled as “man-made object.” The images were generated from 18 different deployments at a single coastal San Diego location (<50 m depth). The deployments occurred during varied environmental conditions within a single calendar year.

Relative to some contemporary deep learning image datasets, the inventor's dataset is relatively small. However, each one of the images was reviewed by multiple human experts in full context with hundreds of adjacent pixels. Additionally, the dataset of images was collected in a maintained range where the locations of certain man-made objects are known, and the surrounding area is periodically examined, and any new man-made objects are removed. Accordingly, the inventors have high confidence that the labels for each image are correct despite the uncertainty inherent in seafloor images. Additionally, the dataset is non-trivial, because it consists only of image tiles which were assigned a non-zero confidence score by a different man-made object detection algorithm. (i.e., all the images contain objects of some type, such as rocks or kelp, none of the “natural object” images are strictly sand or gravel). Anecdotally, non-expert humans struggle to label these images correctly.

### Environmental Sensors on UUV

The UUVs used by the inventors directly measure a variety of environmental data (context metadata). The UUV sensors may include ECO FLNTU™ optical sensors configured for backscattering, turbidity and chlorophyll-a measurements, available from Sea-Bird Scientific, 13431 NE 20th St, Bellevue, WA 98005 USA. The UUV sensors may further include gyroscopes for vehicle posture. Environmental metadata selected for analysis consisted of eight floating point numbers for each image: temperature, salinity, sound speed, chlorophyll a, turbidity, vehicle altitude, vehicle roll, and vehicle pitch. CTD measurements were recorded at 2 Hz, while the other five measurements were captured at 1 Hz. The side scan sonar timestamp was used to locate the nearest metadata timestamp, and the corresponding metadata values were used. Only measured metadata values were used. The metadata was not interpolated.

### Hardware and Software Implementation

It will be understood that any suitable computer system and memory configured to store and execute computer code, provide memory for data storage may be used according to the teachings of the present invention. For example, and not by way of limitation, various embodiments of the invention described herein may be executed within the memory footprint and the processing power of a single NVIDIA® Tesla® V100 Graphical Processing Unit (GPU), available from Nvidia Corporation, 2788 San Tomas Expressway, Santa Clara, CA 95051 USA. Accordingly, the sensing system controller 160 shown in FIG. 1 may be implemented on a single NVIDIA® Tesla® V100 GPU. It will further be understood that any suitable software development environment and computer programming languages may be used consistent with the teachings of the present invention. For example, and not by way of limitation, computer code used by the inventors was written in the Python™ programming language, see python.org. The inventors also made extensive use of the PyTorch library to support model development and evaluation of various embodiments of the present invention, see, e.g., pytorch.org, and A. Paszke et al., “PyTorch: An Imperative Style, High-Performance Deep Learning Library,” 2019, doi: 10.48550/ARXIV.1912.01703, the contents of which are hereby incorporated by reference for all purposes as if fully set forth herein. It will further be understood that various individual network architectures written in Python™, are available on GitHub, see, e.g., github.com.

### Deep Learning Architecture

Deep learning architectures are extensively used for image analysis. However, most deep learning architectures exclusively accept rectangular pixel regions as input, few allow for inclusion of metadata. Accordingly, the inventors selected a deep learning architecture allowing for metadata inclusion. The inventors employed a representative deep learning algorithm from open literature, namely, Vision Transformers (ViT), described in A. Dosovitskiy, L. Beyer, A. Kolesnikov, D. Weissenborn, X. Zhai, T. Unterthiner, M. Dehghani, M. Minderer, G. Heigold, S. Gelly, J. Uszkoreit, and N. Houlsby, “An Image is Worth 16×16 Words: Transformers for Image Recognition at Scale,” 2020, doi: 10.48550/ARXIV.2010.11929, the contents of which are hereby incorporated by reference for all purposes.

### Metadata Inclusion Architectures

FIGS. 5A-5D illustrate exemplary machine learning architectures, including three architectures for including metadata, according to the present invention. FIG. 5A illustrates the “base” architecture, which forms a comparison baseline and does not incorporate environmental metadata during classification. The other architectures illustrated in FIGS. 5B-5D include Concatenation, MetaNet, and MetaBlock, respectively, which do incorporate environmental metadata during classification. The large grey boxes on the left hand side of each architecture represent the ViT feature maps 502. The blue boxes underneath represent the metadata 504. Ellipses represent fully connected neural network layers 506 before a final softmax calculation 508.

The Concatenation metadata inclusion methodology illustrated in FIG. 5B closely follows the work of J. S. Ellen, C. A. Graff, and M. D. Ohman, “Improving plankton image classification using context metadata,” Limnol Oceanogr Methods, vol. 17, no. 8, pp. 439-461, August 2019, doi: 10.1002/lom3.10324, the contents of which are hereby incorporated by reference for all purposes as if fully set forth herein. This particular Ellen et al. paper describes a method called Concatenation appended to a CNN architecture. More particularly, this Ellen et al. paper discloses using a CNN to develop feature maps based exclusively on the pixels, and then injects metadata immediately after the conclusion of the convolutional layers, and before the penultimate fully connected layers. Though multiple strategies are described in this Ellen et al. paper, the inventors used the simplest strategy, which allows for some interaction with the metadata and pixel features.

The MetaBlock and MetaNet metadata inclusion methodologies illustrated in FIGS. 5C and 5D follow closely the work of L. M. de Lima and R. A. Krohling, “Exploring Advances in Transformers and CNN for Skin Lesion Diagnosis on Small Datasets,” 2022, doi: 10.48550/ARXIV.2205.15442, the contents of which are hereby incorporated by reference for all purposes as if fully set forth herein. More particularly, de Lima et al., incorporate the complex metadata fusion methods MetaBlock and MetaNet which are appended to the ViT model.

The MetaBlock metadata fusion methodology shown in FIG. 5C is further described in A. G. C. Pacheco and R. A. Krohling, “An Attention-Based Mechanism to Combine Images and Metadata in Deep Learning Models Applied to Skin Cancer Classification,” in IEEE Journal of Biomedical and Health Informatics, vol. 25, no. 9, pp. 3554-3563 September 2021, doi: 10.1109/JBHI.2021.3062002, hereinafter Pacheco et al., the contents of which are hereby incorporated by reference for all purposes as if fully set forth herein. The MetaBlock implementation described by Pacheco et al. aims to enhance the metadata features extracted from images by capturing interactions with, and adjusting the importance of, linearly transformed metadata through an attention mechanism. The MetaBlock approach to including metadata executes this via element-wise multiplication and addition operations that combine the image features and metadata to introduce bias to yield adjustable weights for backpropagation. These weights allow the model to capture valuable relationships between the two types of input.

The MetaNet metadata fusion methodology shown in FIG. 5D is further described in W. Li, J. Zhuang, R. Wang, J. Zhang and W. S. Zheng, “Fusing Metadata and Dermoscopy Images for Skin Disease Diagnosis,” 2020 IEEE 17th International Symposium on Biomedical Imaging (ISBI), Iowa City, IA, USA, 2020, pp. 1996-2000, doi: 10.1109/ISBI45749.2020.9098645, hereinafter Li et al., the contents of which are hereby incorporated by reference for all purposes as if fully set forth herein. The MetaNet implementation described by Li et al. fuses the metadata and pixel feature maps directly. Metadata is first passed though convolutional layers and activation functions to expand its dimensions to match those of the pixel feature maps. These weights are multiplied together, fusing them into a single image metadata representation. As a result, the metadata directly influences the importance of each feature map at the last convolutional layer.

The inventors exclusively utilized a pretrained ViT model as the testbed for the present invention and engaged in minimal hyperparameter tuning across all trials for consistency. All 8 metadata were standardized to be of zero-mean and unit variance, and the few missing values were replaced by the mean values for that feature. For each of the three trials, a different randomized train-validation-test split of 80%-10%-10% was utilized, with the randomization held constant across all four of the implemented architectures.

### Results

The inventors discovered that the environmental metadata are useful in improving accuracy. For each of the three metadata inclusion methods, the mean accuracy across three trials is higher than the mean accuracy in three equivalent trials of the ViT implementation without metadata inclusion, see Table 1, below. However, only the Concatenation method showed a statistically significant difference in accuracy (at the p=0.05 level).

More particularly, Table 1, below, illustrates results from the four metadata inclusion architectures across three trials, according to the present invention. Percentages shown in Table 1 are rounded balanced accuracy scores, with rows sorted by smallest mean accuracy to greatest over the trials. The P-values were obtained by generating a Welch Two-Sample t-test between the Base and other metadata inclusion methods.

TABLE 1
Metadata Trial Results

| Metadata | | | | | |
|---|---|---|---|---|---|
| Inclusion | Trial | | | Mean | |
| Method | I | II | III | Accuracy | P-Value |
| Base | 68.77% | 69.81% | 68.01% | 68.86% | — |
| MetaNet | 70.77% | 71.64% | 69.02% | 70.48% | 0.1677 |
| MetaBlock | 68.65% | 72.03% | 77.69% | 72.79% | 0.2729 |
| Concatenation | 72.36% | 73.99% | 76.05% | 74.13% | .02281 |

As shown in Table 1, above, the metadata inclusion strategy that performed the best was Concatenation, which also added the fewest trainable parameters to the ViT model. It will be understood that deep learning algorithms have a well-known problem with overfitting on small datasets, i.e., the more free parameters to be trained, the more training data is required. Thus, given a larger amount of training data, the performance gains provided by MetaNet and MetaBlock may increase.

It should also be noted that this dataset only included on-vehicle measurements, which measure the water parameters in immediate proximity to the vehicle. It will be understood that side scan sonar specifically is scanning an area relatively far away from the vehicle. Therefore, the environmental measurements acquired at the same time as the scan are not as useful as environmental measurements located closer to the ensonified seafloor. Accordingly, some type of spatial interpolation of the metadata may yield even better results.

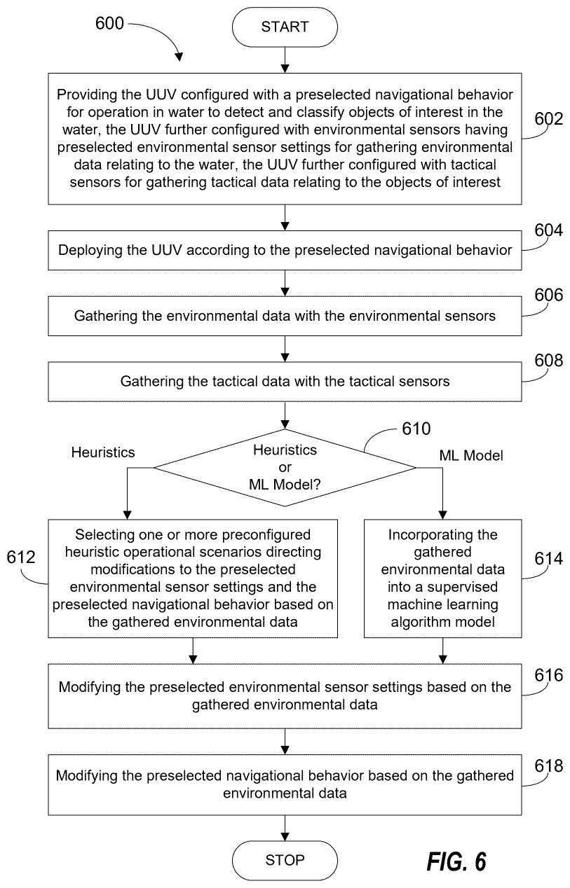

FIG. 6 is a flowchart of an embodiment of a method 600 for improving data gathering performed by an UUV, according to the present invention. The embodiment of a method 600 for improving data gathering performed by an UUV may include providing 602 the UUV configured with a preselected navigational behavior for operation in water to detect and classify objects of interest in the water. An embodiment of the provided 602 UUV may be UUV 100 shown in FIG. 1 and as described herein. The UUV may be further configured with environmental sensors having preselected environmental sensor settings for gathering environmental data relating to the water. An embodiment of the provided 602 environmental sensors may be environmental sensors 170 as shown in FIG. 1 and described herein. The UUV may further be configured with tactical sensors for gathering tactical data relating to the objects of interest in the water. An embodiment of the provided 602 tactical sensors may be tactical sensors 180 as shown in FIG. 1 and as described herein. The embodiment of a method 600 for improving data gathering performed by an UUV may further include deploying 604 the UUV according to the preselected navigational behavior. The embodiment of a method 600 for improving data gathering performed by an UUV may further include gathering the environmental data 606 with the environmental sensors. The embodiment of a method 600 for improving data gathering performed by an UUV may further include gathering the tactical data 608 with the tactical sensors.

The embodiment of a method 600 for improving data gathering performed by an UUV may take one of two paths at decision point 610, either heuristics or machine learning. According to the heuristics path, method 600 may further include selecting one or more preconfigured heuristic operational scenarios 612 directing modifications to the preselected environmental sensor settings and the preselected navigational behavior based on the gathered environmental data. The embodiment of a method 600 for improving data gathering performed by an UUV may further include incorporating 610 the gathered environmental data into a supervised machine learning algorithm model. The embodiment of a method 600 for improving data gathering performed by an UUV may further include modifying the preselected environmental sensor settings 612 based on the gathered environmental data. The embodiment of a method 600 for improving data gathering performed by an UUV may further include modifying the preselected navigational behavior 614 based on the gathered environmental data.

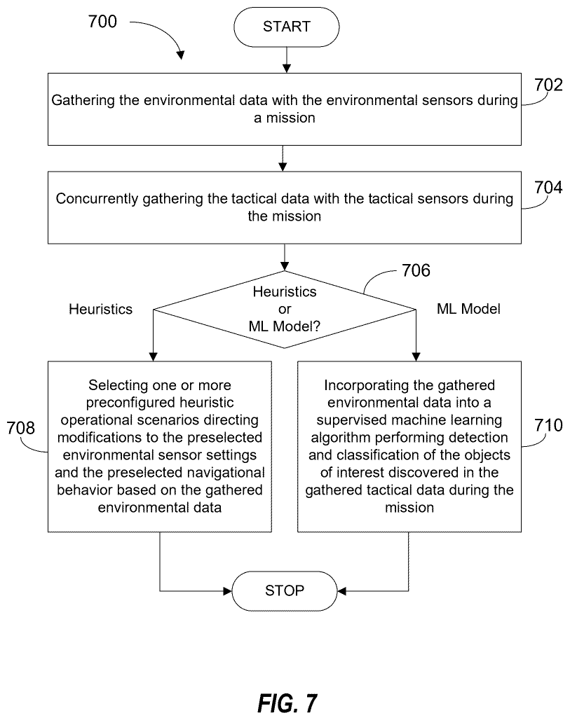

FIG. 7 is a flowchart of an embodiment of a method 700 for improving data collected by an UUV configured with environmental sensors for gathering environmental data relating to water, and further configured with tactical sensors for gathering tactical data relating to objects of interest in the water, according to the present invention. Exemplary environmental sensors may include any of the environmental sensors 170 described herein. Exemplary tactical sensors may include any of the tactical sensors 180 described herein. The embodiment of a method for improving data collected by an UUV may include gathering the environmental data 702 with the environmental sensors during a mission. The embodiment of a method for improving data collected by an UUV may further include concurrently gathering the tactical data 704 with the tactical sensors during the mission.

The embodiment of a method 700 for improving data collected by an UUV may take one of two paths at decision point 706, either heuristics or machine learning. According to the heuristics path, method 700 may further include selecting 708 one or more preconfigured heuristic operational scenarios directing modifications to the preselected environmental sensor settings and the preselected navigational behavior based on the gathered environmental data. Alternatively, according to the machine learning path, the embodiment of a method 700 for improving data collected by an UUV may further include incorporating 710 the gathered environmental data into a supervised machine learning algorithm performing detection and classification of the objects of interest discovered in the gathered tactical data during the mission. Embodiments of the supervised machine learning algorithm incorporating the gathered environmental data 706 may be any suitable supervised machine learning algorithm disclosed herein.

Having described specific embodiments of the present invention with reference to the drawings, additional general embodiments of the present invention are described below.

An uncrewed underwater vehicle (UUV) sensing system controller in communication with an UUV controller, the UUV controller adapted for guiding an UUV according to a preselected navigational behavior during operation of the UUV during a mission, is disclosed. According to this embodiment, the UUV sensing system controller may be further adapted to receive tactical data from tactical sensors located on the UUV and having preselected tactical sensor settings used to find and classify objects of interest under water. According to this embodiment, the UUV sensing system controller may be further adapted to receive environmental data including water parameter measurements from environmental sensors located on an UUV. According to this embodiment, the UUV sensing system controller may be further adapted to output selected modifications to the preselected tactical sensor settings and/or the preselected navigational behavior in response to the environmental data received during the mission, thereby improving in situ tactical data collection performed by the tactical sensors relative to data collection performance without the selected modifications based on the environmental data.

According to another embodiment of an UUV sensing system controller, the environmental data may include at least one of: time of day, date, season, water temperature, water conductivity, water salinity, sound velocity profile, wave data, sea state, turbidity, chlorophyll-a, water fluorescence, water column stability and biological population estimates. Biological population estimates may include, for example and not by way of limitation, the presence or absence of fish in the water, or plankton population counts.

According to yet another embodiment of an UUV sensing system controller, the tactical sensors may include at least one of: active sonar, side scan sonar, optical video and LIDAR. According to still another embodiment of an UUV sensing system controller, the preselected navigational behavior may include at least one of: planned transects, altitude, heading, speed, roll rate, pitch rate, yaw rate, reacquiring an object and following an object. According to still yet another embodiment of an UUV sensing system controller, the outputting of modifications to the preselected navigational behavior may include at least one of: using different tactical sensors, using different sensor emission power levels, and using different sensor sensitivity levels.

According to one embodiment, the UUV sensing system controller may further include a supervised machine learning model trained with ground truth data and configured to receive environmental data in a context metadata vector format and configured to output modifications to the preselected navigational behavior. According to another embodiment of an UUV sensing system controller, the supervised machine learning model performs regression or classification. According to yet another embodiment of an UUV sensing system controller, the improving of the in situ tactical data collection performed by the tactical sensors includes at least one of: reduced time required to acquire the tactical data, increased quality of tactical data acquired, or increased accuracy of resulting identification and classification of the objects of interest.

An UUV including an UUV controller, in communication with a navigation subsystem, a propulsion subsystem, a communication subsystem, a power subsystem, tactical sensors, environmental sensors, and a sensing system controller in communication with the UUV controller, is disclosed. According to this embodiment of an UUV, the UUV may be configured for deployment on a preselected navigational behavior in water to detect and classify objects of interest in the water using the tactical sensors. According to this embodiment of an UUV, the sensing system controller may further include a memory for storing data and a computer program, the computer program including computer instructions for modifying both the preselected navigational behavior and tactical sensor operating characteristics in response to environmental data gathered by the environmental sensors. According to this embodiment of an UUV, the sensing system controller may further include a processor in communication with the environmental sensors, the tactical sensors, and the memory, the processor configured for executing the computer program.

According to another embodiment of the UUV, the environmental data may include at least one of: time of day, date, season, water temperature, water conductivity, water salinity, sound velocity profile, wave data, sea state, turbidity, chlorophyll-a, water fluorescence, water column stability and biological population estimates. According to yet another embodiment of the UUV, the tactical data may include at least one of: active sonar, side scan sonar, optical video and LIDAR. According to still another embodiment of the UUV, the preselected navigational behavior may include at least one of: planned transects, altitude, heading, speed, roll rate, pitch rate, yaw rate, reacquiring an object and following an object. According to still yet another embodiment of the UUV, the processor may be a graphics processing unit.

An embodiment of a method for improving data gathering performed by an UUV is disclosed. The method for improving data gathering may include providing the UUV configured with a preselected navigational behavior for operation in water to detect and classify objects of interest in the water. According to this embodiment of a method for improving data gathering, the UUV may further be configured with environmental sensors having preselected environmental sensor settings for gathering environmental data relating to the water, the UUV further configured with tactical sensors for gathering tactical data relating to the objects of interest. The method for improving data gathering may further include deploying the UUV according to the preselected navigational behavior. The method for improving data gathering may further include gathering the environmental data with the environmental sensors. The method for improving data gathering may further include gathering the tactical data with the tactical sensors. The method for improving data gathering may further include selecting one or more preconfigured heuristic operational scenarios directing modifications to the preselected environmental sensor settings and the preselected navigational behavior based on the gathered environmental data, or alternatively, incorporating the gathered environmental data into a supervised machine learning algorithm model. The method for improving data gathering may further include modifying the preselected environmental sensor settings based on the gathered environmental data. The method for improving data gathering may further include modifying the preselected navigational behavior based on the gathered environmental data.

According to another embodiment of a method for improving data gathering performed by an UUV, the tactical data may include at least one of: active sonar, side scan sonar, optical video and LIDAR. According to yet another embodiment of a method for improving data gathering performed by an UUV, the preselected navigational behavior may include at least one of: planned transects, altitude, heading, speed, roll rate, pitch rate and yaw rate. According to still another embodiment of a method for improving data gathering performed by an UUV, the environmental data may include at least one of: time of day, date, season, water temperature, water conductivity, water salinity, sound velocity profile, wave data, sea state, turbidity, chlorophyll-a, water fluorescence, water column stability and biological population estimates.

According to one embodiment of a method for improving data gathering performed by an UUV, the UUV may further be configured with a sensing system controller in communication with the environmental sensors and the tactical sensors. According to this embodiment of a method for improving data gathering performed by an UUV, the sensing system controller may further be configured to modify the preselected navigational behavior by either preconfigured heuristic operational scenarios, or the output of a supervised machine learning algorithm model. According to still yet another embodiment of a method for improving data gathering performed by an UUV, the supervised machine learning algorithm model may be any one of the following: Support Vector Machine, Convolutional Neural Network and Vision Transformers algorithm.

An embodiment of a method for improving data collected by an UUV configured with environmental sensors for gathering environmental data relating to water, and further configured with tactical sensors for gathering tactical data relating to objects of interest in the water is disclosed. The embodiment of a method for improving data collected by an UUV may include gathering the environmental data with the environmental sensors during a mission. The embodiment of a method for improving data collected by an UUV may further include concurrently gathering the tactical data with the tactical sensors during the mission. The embodiment of a method for improving data collected by an UUV may further include selecting one or more preconfigured heuristic operational scenarios directing modifications to the preselected environmental sensor settings and the preselected navigational behavior based on the gathered environmental data, or alternatively, incorporating the gathered environmental data into a supervised machine learning algorithm performing detection and classification of the objects of interest discovered in the gathered tactical data during the mission.

According to a particular embodiment of the method for improving data collected by an UUV, the tactical data may include at least one of: active sonar, side scan sonar, optical video and LIDAR. According to another embodiment of the method for improving data collected by an UUV, the environmental data may include at least one of: time of day, date, season, water temperature, water conductivity, water salinity, sound velocity profile, wave data, sea state, turbidity, chlorophyll a, water fluorescence, water column stability, and biological population estimates. According to yet another embodiment of the method for improving data collected by an UUV, the supervised machine learning algorithm may be a Convolutional Neural Network, or a Vision Transformers algorithm. According to yet another embodiment of the method for improving data collected by an UUV, the supervised machine learning algorithm processing the tactical data may further incorporate the gathered environmental data using at least one of: MetaNet, MetaBlock and Concatenation metadata inclusion strategies.

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Finally, terms of degree such as “substantially”, “about” and “approximately” as used herein mean a reasonable amount of deviation of the modified term such that the end result is not significantly changed.

From the above description of the embodiments of a system and method for improving underwater sensing, it is manifest that various alternative structures may be used for implementing features of the present invention without departing from the scope of the claims. The described embodiments are to be considered in all respects as illustrative and not restrictive. It will further be understood that the present invention may suitably comprise, consist of, or consist essentially of the component parts, method steps and limitations disclosed herein. The method and/or apparatus disclosed herein may be practiced in the absence of any element that is not specifically claimed and/or disclosed herein.

While the foregoing advantages of the present invention are manifested in the detailed description and illustrated embodiments of the invention, a variety of changes can be made to the configuration, design and construction of the invention to achieve those advantages. Hence, reference herein to specific details of the structure and function of the present invention is by way of example only and not by way of limitation.

What is claimed is:

1. An uncrewed underwater vehicle (UUV) sensing system controller in communication with an UUV controller, the UUV controller adapted for guiding an UUV according to a preselected navigational behavior during operation of the UUV during a mission, the UUV sensing system controller further adapted to:
receive tactical data from tactical sensors located on the UUV and having preselected tactical sensor settings used to find and classify objects of interest under water;
receive environmental data including water parameter measurements from environmental sensors located on the UUV; and
output selected modifications to the preselected tactical sensor settings and/or the preselected navigational behavior in response to the environmental data received during the mission, thereby improving in situ tactical data collection performed by the tactical sensors relative to data collection performance without the selected modifications based on the environmental data.

2. The UUV sensing system controller according to claim 1, wherein the environmental data comprises at least one of: time of day, date, season, water temperature, water conductivity, water salinity, sound velocity profile, wave data, sea state, turbidity, chlorophyll-a, water fluorescence, water column stability and biological population estimates.

3. The UUV sensing system controller according to claim 1, wherein the tactical sensors comprises at least one of: active sonar, side scan sonar, optical video and LIDAR (Light Detection and Ranging).

4. The UUV sensing system controller according to claim 1, wherein the preselected navigational behavior comprises at least one of: planned transects, altitude, heading, speed, roll rate, pitch rate, yaw rate, reacquiring an object and following an object.

5. The UUV sensing system controller according to claim 1, wherein the outputting of modifications to the preselected navigational behavior may include at least one of: using different tactical sensors, using different sensor emission power levels, and using different sensor sensitivity levels.

6. The UUV sensing system controller according to claim 1, further comprising a supervised machine learning model trained with ground truth data and configured to receive environmental data in a context metadata vector format and configured to output modifications to the preselected navigational behavior.

7. The UUV sensing system controller according to claim 6, wherein the supervised machine learning model performs regression or classification.

8. The UUV sensing system controller according to claim 1, wherein the improving of the in situ tactical data collection performed by the tactical sensors includes at least one of: reduced time required to acquire the tactical data, increased quality of tactical data acquired, or increased accuracy of resulting identification and classification of the objects of interest.

9. An uncrewed underwater vehicle (UUV) including an UUV controller, in communication with a navigation subsystem, a propulsion subsystem, a communication subsystem, a power subsystem, tactical sensors, environmental sensors, and a sensing system controller in communication with the UUV controller, wherein the UUV is configured for deployment on a preselected navigational behavior in water to detect and classify objects of interest in the water using the tactical sensors, the sensing system controller further comprising:
a memory for storing data and a computer program, the computer program including computer instructions for modifying both the preselected navigational behavior and tactical sensor operating characteristics in response to environmental data gathered by the environmental sensors; and
a processor in communication with the environmental sensors, the tactical sensors, and the memory, the processor configured for executing the computer program.

10. The UUV according to claim 9, wherein the environmental data comprises at least one of: time of day, date, season, water temperature, water conductivity, water salinity, sound velocity profile, wave data, sea state, turbidity, chlorophyll-a, water fluorescence, water column stability and biological population estimates.

11. The UUV according to claim 9, wherein the tactical data comprises at least one of: active sonar, side scan sonar, optical video and LIDAR (Light Detection and Ranging).

12. The UUV according to claim 9, wherein the preselected navigational behavior comprises at least one of: planned transects, altitude, heading, speed, roll rate, pitch rate, yaw rate, reacquiring an object and following an object.

13. The UUV according to claim 9, wherein the processor comprises a graphics processing unit.

14. A method for improving data gathering performed by an uncrewed underwater vehicle (UUV), the method comprising:
providing the UUV configured with a preselected navigational behavior for operation in water to detect and classify objects of interest in the water, the UUV further configured with environmental sensors having preselected environmental sensor settings for gathering environmental data relating to the water, the UUV further configured with tactical sensors for gathering tactical data relating to the objects of interest;
deploying the UUV according to the preselected navigational behavior;
gathering the environmental data with the environmental sensors;
gathering the tactical data with the tactical sensors;
selecting one or more preconfigured heuristic operational scenarios directing modifications to the preselected environmental sensor settings and the preselected navigational behavior based on the gathered environmental data, or alternatively, incorporating the gathered environmental data into a supervised machine learning algorithm model;
selectively modifying the preselected environmental sensor settings; and
selectively modifying the preselected navigational behavior.

15. The method according to claim 14, wherein the tactical data comprises at least one of: active sonar, side scan sonar, optical video and LIDAR (Light Detection and Ranging).

16. The method according to claim 14, wherein the preselected navigational behavior comprises at least one of: planned transects, altitude, heading, speed, roll rate, pitch rate and yaw rate.

17. The method according to claim 14, wherein the environmental data comprises at least one of: time of day, date, season, water temperature, water conductivity, water salinity, sound velocity profile, wave data, sea state, turbidity, chlorophyll-a, water fluorescence, water column stability and biological population estimates.

18. The method according to claim 14, wherein the UUV is further configured with a sensing system controller in communication with the environmental sensors and the tactical sensors, the sensing system controller further configured to modify the preselected navigational behavior by either preconfigured heuristic operational scenarios, or the output of a supervised machine learning algorithm model.

19. The method according to claim 14, wherein the supervised machine learning algorithm model is selected from the group consisting of: Support Vector Machine, Convolutional Neural Network and Vision Transformers algorithm.

20. A method for improving data collected by an uncrewed underwater vehicle (UUV) configured with environmental sensors for gathering environmental data relating to water, the UUV further configured with tactical sensors for gathering tactical data relating to objects of interest in the water, the method comprising:
gathering the environmental data with the environmental sensors during a mission;
concurrently gathering the tactical data with the tactical sensors during the mission;
selecting one or more preconfigured heuristic operational scenarios directing modifications to the preselected environmental sensor settings and the preselected navigational behavior based on the gathered environmental data, or alternatively, incorporating the gathered environmental data into a supervised machine learning algorithm performing detection and classification of the objects of interest discovered in the gathered tactical data during the mission.

21. The method according to claim 20, wherein the tactical data comprises at least one of: active sonar, side scan sonar, optical video and LIDAR (Light Detection and Ranging).

22. The method according to claim 20, wherein the environmental data comprises at least one of: time of day, date, season, water temperature, water conductivity, water salinity, sound velocity profile, wave data, sea state, turbidity, chlorophyll a, water fluorescence, water column stability, and biological population estimates.

23. The method according to claim 20, wherein the supervised machine learning algorithm is selected from the group consisting of: Convolutional Neural Network and Vision Transformers algorithm.

24. The method according to claim 20, wherein the supervised machine learning algorithm processing the tactical data further incorporates the gathered environmental data using at least one of: MetaNet, MetaBlock and Concatenation metadata inclusion strategies.
